(19) United States
(12) Patent Application Publication
(10) Pub. No.: US 2025/0348399 A1
(43) Pub. Date: Nov. 13, 2025

(54) ITERATIVE METHOD FOR MONITORING A COMPUTING DEVICE

(71) Applicant: BULL SAS, Les Clayes-sous-Bois (FR)

(72) Inventors: Gloria CAPANO, Lausanne (CH); Evgeniy PONOMAREV, Geneva (CH); Natalia MICHALEK, Gdansk (PL)

(73) Assignee: BULL SAS, Les Clayes-sous-Bois (FR)

(21) Appl. No.: 19/275,955

(22) Filed: Jul. 21, 2025

Related U.S. Application Data
(63) Continuation-in-part of application No. 18/311,333, filed on May 3, 2023.

(30) Foreign Application Priority Data
May 12, 2022 (EP) 22305701.9

(51) Int. Cl. G06F 11/30; G06F 9/50; G06F 11/32

(52) U.S. Cl. CPC G06F 11/3072; G06F 9/5022; G06F 11/327

(57) ABSTRACT

An iterative method for monitoring a computing device characterized by metric data to be monitored, including, for each iteration, of collecting metric data over a predetermined interval of time, detecting a seasonality pattern of said metric data over said predetermined interval of time, determining an interval-specific model representing the detected seasonality pattern, calculating modelled data using said determined model and the collected metric data, comparing the calculated modelled data with the collected metric data to calculate a score characterizing the difference between the calculated modelled data and the collected metric data, calculating an anomaly likelihood for each data of the collected metric data using the calculated score, detecting an anomaly on a data when probability that the value of said data is an anomaly is greater than a predetermined threshold.

This application is a continuation-in-part of U.S. patent application Ser. No. 18/311,333, filed on 3 May 2023, which claims priority to European Patent Application Number 22305701.9, filed 12 May 2022, the specification of which is hereby incorporated herein by reference.

### BACKGROUND OF THE INVENTION

### Field of the Invention

At least one embodiment of the invention relates to monitoring of computing devices and, more particularly, to a device and a method for an iterative method, a device and a system for monitoring a computing device.

### Description of the Related Art

Real-time detection of technical problems in computing processes and services is a major challenge, in particular in Information Technology (IT). In the next years, it is expected an increasing adoption of IT operations driven by data operations and accelerated by the COVID-19 crisis that led to an expansion of remote workforce. An increase in resources is followed by a proportional increase in IT manutention work that takes different flavors. One of them is the monitoring of servers functioning and their applications. The objective of monitoring is to inform the engineers of the IT operations teams if and when an issue is present, ideally before users experience any effect. The most common way of performing monitoring is to collect periodically metrics of interest, such as e.g., CPU total consumption, memory utilization, or filesystem usage on servers, Virtual Machine (VM) instances or other hardware, and to apply threshold values to the collected metrics to make decisions.

In the static monitoring threshold approach, if the value of the metric is above a predefined threshold value for a certain interval of time, an alert is triggered and sent to an engineer that may intervene to check the status of the service and solve eventual problems. The threshold reflects what must be considered as “acceptable performance” and can be adjusted by the IT team to reflect the business criticality of certain servers and/or applications. Many commercial monitoring tools adopt this strategy. However, setting a pre-defined threshold might lead to some constraints.

First of all, setting a too low threshold leads to an inflation of triggered alerts whose majority would not be related to an actual problem (false positive alerts). The lower the threshold, one might get a higher false-positive/true-positive alerts ratio and a higher absolute number of alerts to analyze.

Secondly, setting a high threshold reduces the false-positive alert number but it would not be able to eradicate them. Also, if a too high threshold is set, true positive alerts might be triggered too late, giving engineers less time to prevent a problem (e.g., if a database is experiencing an increasing number of simultaneous transactions that might cause the system to not accommodate all of them. A too high threshold might warn engineers only when the database is close to a critical situation).

Thirdly, different VMs hosted on the same server might be assigned with the same pre-defined threshold despite their different business applications. It requires extra manual work to set threshold uniquely for each Virtual Machine.

Finally, servers might change the hosted applications, or applications might be used in a different way over time (low flexibility). Hence, static pre-defined thresholds cannot capture these modifications and they need to be manually changed to better reflect the new situation.

Some of these issues can be alleviated by using a dynamic threshold approach which can recognize cyclic patterns of activities. The dynamic thresholds are calculated by anomaly detection algorithms based on historical data. The algorithms define what normal behavior is at a particular time (days, weeks) and an alert is triggered if the evaluated metric bypasses the value expected as normal. Dynamic threshold techniques may reduce false-positive alerts and may attenuate some of the problems derived by the static threshold approach. In general, a dynamic threshold lessens the need for manual setting of thresholds and parameters providing at the same time a smaller false positive/true positive ratio and a decreased risk of imposing a too high threshold value. Nevertheless, dynamic threshold approaches hugely vary according to the anomaly algorithm in use: simpler algorithms require less computation power, but they are based on strong a priori that make them neither too flexible nor too precise (e.g., some anomaly detection techniques expect that a certain percentage of data are anomalous; this percentage depends drastically on the particular use case—server, application—and it cannot be correctly calculated across several IT services).

Other more complex techniques, such as the ones based on deep learning, are computationally very expensive, making them less feasible to be employed for real-time detection of large IT systems. Also, when talking about capturing seasonal (i.e., recurrent) behavior with dynamical threshold, existing techniques require a large amount of historical data, especially in the case of composite cycles (e.g., applications used only during working days, from Monday to Friday, with a break during the weekend). Although dynamical thresholds monitoring tools should be able to detect seasonal cycle, they should also be flexible enough to adapt to changes in the “normal” behavior or in seasonal patterns (e.g., backup day shifts from Monday to Tuesday, or a new application has been installed on the server). At the same time, they should be robust enough to detect malicious applications (e.g., an unexpected application running during holiday) and not learn from them.

In summary, the dynamical threshold approach has several limitations due to the complexity and computation cost correlation, the need for a large amount of historical data, the compromise between catching seasonal cycles and at the same time adjusting to a new normality and the demand of resilience to local changes.

A solution entitled “Unsupervised method for baselining and anomaly detection in time-series data for enterprise systems” (U.S. Pat. No. 10,635,563B2) describes the use of several models to predict values of relevant IT operational metrics. This solution implements a statistical approach to historical data to determine the presence of anomalies. Specifically, for prediction, such models as Holt-Winters, ARIMA, and Maximum Concentration Intervals are used. An anomaly event is raised once the value of the monitored metric goes outside of a tolerance interval. Tolerance intervals are calculated statistically on previously acquired data. To perform anomaly detection more precisely, the authors also introduce a seasonality check procedure which allows determining whether there are any periodic patterns present in the data. Once the seasonality period is determined, the data is split into intervals equal to the period. Statistical quantities such as mean and standard deviation are evaluated separately for each interval.

Another solution covering seasonality identification in time series is presented in the document entitled “Unsupervised method for classifying seasonal patterns” (U.S. Patent Application No. 2020/0258005 A1). The method for seasonality detection proposed by the authors relies on splitting time series of interest into one or several seasonal intervals and calculating correlation coefficients between time adjacent intervals. If thus obtained correlation coefficients are above certain pre-defined values, then the time series is labelled with respective seasonality.

To determine the presence of seasonality patterns (hourly, daily, weekly etc.), some solutions (described in U.S. Pat. No. 10,635,563B2 and U.S. Patent Application No. 2020/0258005 A1) employ a rather rigid and not flexible approach based on comparing time-adjacent intervals of data and calculating correlation coefficients. When the correlation coefficients are above certain pre-defined values the presence of respective seasonal patterns is identified. The key drawback of this method is that it is tuned to capture fixed temporal patterns and can struggle to determine non-typical patterns. For example, when the incoming data is composed of periodically appearing daily peaks of different amplitude which are not exactly equally spaced.

Another potential flaw of the proposed approach is the way tolerance intervals are calculated. Once the presence of one or several periodic patterns is detected the data is split into buckets, i.e., intervals, of respective length (hourly/daily/weekly etc.). The statistical quantities such as mean and standard deviation are evaluated for each corresponding bucket separately. For instance, for a time series with an hourly pattern, the tolerance interval for 00:00-01:00 hour bucket of day N is calculated based on the statistics acquired for the same 00:00-01:00 time window of N−1 previous days. This approach adjusts very slowly to new developing patterns and hence can make wrong predictions whether the incoming data is anomalous or not.

It is therefore an object of one or more embodiments of the invention to provide a solution for solving at least partially these drawbacks.

### BRIEF SUMMARY OF THE INVENTION

To this end, at least one embodiment of the invention concerns an iterative method for monitoring a computing device, said computing device being characterized by metric data to be monitored, said iterative method comprising the steps, for each iteration, of:
collecting metric data over a predetermined interval of time,
detecting a seasonality pattern of said metric data over said predetermined interval of time,
determining an interval-specific model representing the detected seasonality pattern,
calculating modelled data using said determined model and the collected metric data,
comparing the calculated modelled data with the collected metric data to calculate a score characterizing the difference between the calculated modelled data and the collected metric data,
calculating an anomaly likelihood for each data of the collected metric data using the calculated score, said anomaly likelihood being the probability that the value of said data is an anomaly,
detecting an anomaly on a data when probability that the value of said data is an anomaly is greater than a predetermined threshold.

By updating the model parameters at each iteration, the method according to one or more embodiments of the invention allows to dynamically adapt the anomaly detection to the changes in metric data. The metric data are not directly compared to static or dynamic thresholds, so that a change in the values of said metric data does not imply a modification of a threshold. The real-time self-adjustable anomaly detection monitoring method according to the invention self-adjusts on real-time to new seasonality patterns and new “normal” behavior and is robust to local variations.

In at least one embodiment, the device is a computer or a server or a cluster of computers and/or servers.

According to at least one embodiment, the modelled data ŷ_{t+h|t} is calculated at time (t+h) according to the following formula:

$${\hat{y}}_{t + h \vert f} = {l}_{t} + {hb}_{t} + {s}_{t + h - m ( k + 1 )}$$

where:

the level lₜ at time t is defined as:

$${l}_{t} = α ( {y}_{t} - {s}_{t - m} ) + ( 1 - α ) ( {l}_{t - 1} + {b}_{t - 1} )$$

where α is a level coefficient,

the trend component bₜ at time t is defined as:

$${b}_{t} = β * ( {l}_{t} - {l}_{t - 1} ) + ( 1 - β \text{*)} {b}_{t - 1}$$

where β is a trend coefficient,

the seasonality component is added as follow:

$${s}_{t} = γ ( {y}_{t} - {l}_{t - 1} - {b}_{t - 1} ) + ( 1 - γ ) {s}_{t - m}$$

where γ is a season coefficient.

Advantageously, in one or more embodiments, wherein the score deviates from the mean of the N previous calculated scores when the anomaly-likelihood function L is below a predetermined threshold, where:

$$L = 1 - \frac{1}{2} erfc ( \frac{x - MN}{\sqrt{2} \times STD} )$$

and where x is the mean of the n previous calculated scores with N>>n, MN is the mean of the N previous calculated scores and STD is the standard deviation of the N previous calculated scores with N>>n.

The detection of the seasonality pattern of the metric data over the predetermined interval of time may comprise identifying said seasonality pattern, by way of at least one embodiment.

The step of detecting the seasonality pattern of said metric data over said predetermined interval of time may comprise retrieving a previously detected pattern or determining a new pattern by way of at least one embodiment.

In at least one embodiment, the seasonality pattern is a simple seasonality pattern consisting of a similar and periodically repeated pattern. In other words, in one or more embodiments, the seasonality pattern is a periodic repetition of a similar peak of values of the data over the interval of time, for example a daily repetition.

In at least one embodiment, the seasonality pattern is a composite seasonality pattern that comprises a combination of at least one peak of values of the collected metric data and of at least one peak of different shape or amplitude or duration of metric data and/or no peak. For example, by way of at least one embodiment, such composite seasonality pattern may arise on one week and comprise a similar peak of metric data on weekdays and a peak of different shape and/or no peak on weekend days.

The real-time self-adjustable anomaly detection monitoring method according to one or more embodiments of the invention with a composite seasonality pattern recognition algorithm has a low computational cost, self-adjusts on real-time to new seasonality patterns and new “normal” behavior, is robust to local variations and calculates composite seasonality patterns with a reduced number of historical data.

At least one embodiment of the invention also relates to a computer program comprising instructions which, when the program is executed by a computer, cause the computer to carry out the steps of the method according to any one of the preceding claims.

At least one embodiment of the invention also relates to a monitoring module for monitoring a computing device, said computing device being characterized by metric data to be monitored, said monitoring module being configured to:
collect metric data over a predetermined interval of time,
detect a seasonality pattern of said metric data over said predetermined interval of time,
determine an interval-specific model representing the detected seasonality pattern,
calculate modelled data using said determined model and the collected metric data,
compare the calculated modelled data with the collected metric data to calculate a score characterizing the difference between the calculated modelled data and the collected metric data,
calculate an anomaly likelihood for each data of the collected metric data using the calculated score, said anomaly likelihood being the probability that the value of said data is an anomaly,
detect an anomaly on a data when probability that the value of said data is an anomaly is greater than a predetermined threshold.

According to at least one embodiment, the monitoring module is configured to calculate the modelled data ŷ_{t+1|t} at time (t+h) according to the following formula:

$${\hat{y}}_{t + h \vert f} = {l}_{t} + {hb}_{t} + {s}_{t + h - m ( k + 1 )}$$

where:

the level lₜ at time t is defined as:

$${l}_{t} = α ( {y}_{t} - {s}_{t - m} ) + ( 1 - α ) ( {l}_{t - 1} + {b}_{t - 1} )$$

the trend component bₜ at time t is defined as:

$${b}_{t} = β * ( {l}_{t} - {l}_{t - 1} ) + ( 1 - β \text{*)} {b}_{t - 1}$$

the seasonality component is added as follow:

$${s}_{t} = γ ( {y}_{t} - {l}_{t - 1} - {b}_{t - 1} ) + ( 1 - γ ) {s}_{t - m}$$

Advantageously, by way of at least one embodiment, the anomaly likelihood L is calculated as follows:

$$L = 1 - \frac{1}{2} erfc ( \frac{x - MN}{\sqrt{2} \times STD} )$$

where x is the mean of the n previous calculated scores, MN is the mean and STD is the standard deviation of the N previous calculated scores with N>>n.

Advantageously, by way of at least one embodiment, the monitoring module is configured, when a seasonality pattern has been detected, for identifying said seasonality pattern.

At least one embodiment, the monitoring module is configured, when detecting the seasonality pattern of said metric data over said predetermined interval of time, to retrieve a previously detected pattern or determine a new pattern.

In at least one embodiment, the seasonality pattern is a simple seasonality pattern consisting of a similar and periodically repeated pattern. In other words, the seasonality pattern is a periodic repetition of a similar peak of values of the data over the interval of time, for example a daily repetition.

In at least one embodiment, the seasonality pattern is a composite seasonality pattern comprising a combination of at least one peak of values of metric data and at least one peak of different shape or amplitude or duration of metric data or no peak. For example, in one or more embodiments, such composite seasonality pattern may arise on one week and comprise a similar peak of metric data on weekdays and a peak of different shape and/or no peak on weekend days.

At least one embodiment of the invention also relates to a computing system comprising a monitoring module according to the preceding claim and a computing device, said computing device being characterized by metric data to be monitored.

In at least one embodiment, the device is a computer or a server or a cluster of computers and/or servers.

In one or more embodiments, the computing device includes one or more resources. In at least one embodiment, the method includes transmitting the anomaly that is detected to a controller and modifying one or more system operation parameters, via the controller, when the anomaly likelihood exceeds a dynamic threshold over a moving time window. In at least one embodiment, the anomaly detection may occur via a separate anomaly detector coupled to the monitoring module and the controller.

In one or more embodiments, the modifying the one or more system operation parameters, via the controller, includes one or more of enabling or disabling features of the computing device based on the seasonality pattern that is detected or based on a frequency of the anomaly, allocating or deallocating the one or more resources; issuing an alert when the anomaly likelihood exceeds the dynamic threshold over the moving time window, wherein the alert may include a severity level, a predicted metric value, an affected resource of the one or more resources, and a timestamp of the anomaly.

In at least one embodiment, the modifying the one or more system operation parameters, via the controller, may include generating a recommendation in response to the anomaly that is detected, the recommendation including a proposed action including one or more of scaling resources, rescheduling tasks, terminating a process, initiating a backup, retraining the interval-specific model, or throttling a service of the computing device.

In at least one embodiment, the reallocating the one or more resources is in anticipation of predicted performance degradation based on historical pattern analysis. In one or more embodiments, the method also includes predicting resource usage of the one or more resources of the computing device ahead of time based on historical telemetry data of the seasonality pattern of the metric data over time. In at least one embodiment, the predicting the resource usage is used to trigger automatic provisioning or deprovisioning of the one or more resources.

In one or more embodiments, the anomaly is defined as a deviation from a predicted normal system usage path determined by the interval-specific model.

In one or more embodiments, the method also includes transmitting outputs of the modelled data to an enterprise dashboard in real time.

By way of one or more embodiments, the enabling or disabling features of the computing device may include one or more of enabling or disabling processor cores or adjusting processor frequency; activating or suspending swap memory or cache flush operations; toggling GPU acceleration or compute offload modes; enabling, disabling, or throttling network interfaces or communication protocols; modifying operating system-level policies including scheduling, logging, or process isolation; activating or suspending background services or job schedulers; enabling enhanced security protocols, restricting network access, or disabling application-level modules.

In at least one embodiment, the modifying the one or more system operation parameters, via the controller, includes modifying one or more of hardware subsystems of the computing device, operating system configuration parameters, active or scheduled processes, access control policies, application service states.

In one or more embodiments, the modifying the one or more system operation parameters, via the controller, includes modifying the system operation parameters based on whether the anomaly that is detected is classified as transient, persistent, or predictive in nature.

At least one embodiment of the invention includes a closed-loop feedback mechanism wherein an outcome of the modifying the one or more system operation parameters from the controller is fed back into the monitoring module to refine future forecasts.

In one or more embodiments, the allocating or deallocating the one or more resources, via the controller, includes using an orchestration platform API.

In at least one embodiment, the allocating the one or more resources includes instantiating one or more virtual machines, containers, or computing nodes.

In one or more embodiments, the deallocating the one or more resources includes terminating low-priority services or migrating workloads to lower-utilization hardware.

### BRIEF DESCRIPTION OF THE DRAWINGS

These and other features, aspects, and advantages of the one or more embodiments of the invention are better understood regarding the following Detailed Description of Invention, appended Claims, and accompanying Figures, where:

FIG. 1 illustrates an embodiment of the computing system according to one or more embodiment of the invention.

FIG. 2 illustrates an example of a simple seasonality pattern, according to one or more embodiments of the invention.

FIG. 3 illustrates an example of a composite seasonality pattern, according to one or more embodiments of the invention.

FIG. 4 illustrates an example of a wavelet transform 2D map, according to one or more embodiments of the invention.

FIG. 5 illustrates an example of the method according to one or more embodiments of the invention.

FIG. 6 illustrates an example of a computing system including a monitoring module and a controller module according to one or more embodiments of the invention.

### DETAILED DESCRIPTION OF THE INVENTION

The Specification, which includes the Summary of Invention, Brief Description of the Drawings and the Detailed Description of the Invention, and the appended Claims refer to particular features (including process or method steps) of the one or more embodiments of the invention. Those of skill in the art understand that the one or more embodiments of the invention include all possible combinations and uses of particular features described in the Specification. Those of skill in the art understand that the at least one embodiment of the invention is not limited to or by the description of embodiments given in the Specification. The inventive subject matter is not restricted except only in the spirit of the Specification and appended Claims. Those of skill in the art also understand that the terminology used for describing the one or more embodiments does not limit the scope or breadth of the invention. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which the one or more embodiments belong unless defined otherwise. As used in the Specification and appended Claims, the singular forms “a”, “an”, and “the” include plural references unless the context clearly indicates otherwise. The verb “comprises”, and its conjugated forms should be interpreted as referring to elements, components, or steps in a non-exclusive manner. The referenced elements, components or steps may be present, utilized or combined with other elements, components or steps not expressly referenced. The verb “couple” and its conjugated forms means to complete any type of required junction, including electrical, mechanical or fluid, to form a singular object from two or more previously non-joined objects. If a first device couples to a second device, the connection can occur either directly or through a common connector. “Optionally” and its various forms means that the subsequently described event or circumstance may or may not occur. The description includes instances where the event or circumstance occurs and instances where it does not occur. “Operable” and its various forms means fit for its proper functioning and able to be used for its intended use. Where the Specification or the appended Claims provide a range of values, it is understood that the interval encompasses each intervening value between the upper limit and the lower limit as well as the upper limit and the lower limit. The at least one embodiment of the invention encompasses and bounds smaller ranges of the interval subject to any specific exclusion provided. Where the Specification and appended Claims reference a method comprising two or more defined steps, the defined steps can be carried out in any order or simultaneously except where the context excludes that possibility.

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

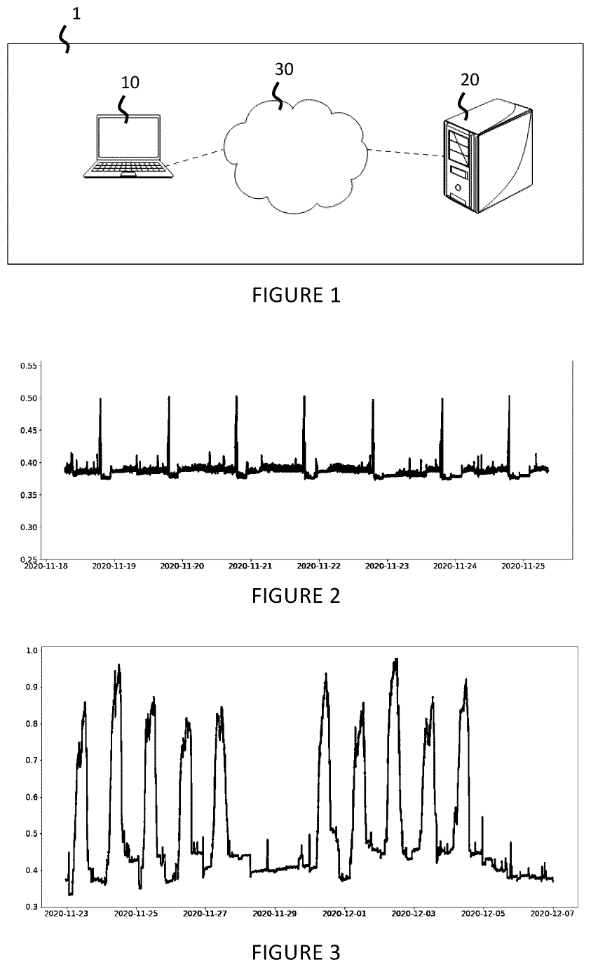

FIG. 1 illustrates an example of the computing system 1, according to one or more embodiments of the invention.

The computing system 1 comprises a monitoring module 10 and a computing device 20.

The computing device 20 may be a computer or a server or a cluster of computers and/or servers.

The computing device 20 is characterized by one or more metric data to be monitored. For example, in at least one embodiment, such metric data may be the total CPU consumption of the computing device 20, the memory usage of the computing device 20 or the number of applications running the computing device 20.

Metric data may be generated by an agent installed on the computing device 20, such as e.g., a Virtual Machine (VM) or similar, which collects values from variables of interest to analyze at regular or irregular time intervals. The agent may generate data that are or are not time equispaced with successive values. In the latter case, data may be transformed into an equispaced time-series by using mean, median, linear extrapolation and other techniques.

The monitoring module 10 allows to monitor the computing device 20. In the example of FIG. 1, according to one or more embodiments of the invention, the monitoring module 10 monitors the computing device 20 through a communication network 30. However, in at least one embodiment, the monitoring module 10 could monitor the computing device 20 directly, through a direct communication link such as e.g., a cable. In the example of FIG. 1, by way of at least one embodiment, the monitoring module 10 is implemented on a laptop computer but could be operated by any adapted computing device.

The monitoring module 10 is configured to collect metric data over a predetermined interval of time.

The monitoring module 10 is configured to detect at least one seasonality pattern of said metric data over said predetermined interval of time.

The monitoring module 10 is configured to determine an interval-specific model representing the at least one detected seasonality pattern.

The monitoring module 10 is configured to calculate modelled data using said determined model and the collected metric data.

The monitoring module 10 is configured to compare the calculated modelled data with the collected metric data to calculate a score characterizing the difference between the calculated modelled data and the collected metric data.

The monitoring module 10 is configured to calculate an anomaly likelihood for each data of the collected metric data using the calculated score, said anomaly likelihood being the probability that the value of said data is an anomaly.

The monitoring module 10 is configured to detect an anomaly on a data when probability that the value of said data is an anomaly is greater than a predetermined threshold.

The monitoring module 10 is configured to realize the above-mentioned functions in an iterative manner.

The monitoring module 10 comprises at least one processor that can implement said above-mentioned functions.

### Example of Operation

An example of implementation of the method is described below in reference to FIGS. 2 to 5, according to one or more embodiments of the invention.

The method is based on four main phases: data collection and transformation, seasonality check and calculation, data forecast and anomaly likelihood assessment. At the end of the anomaly likelihood assessment, one can decide to leave the system, or continue it in a loop, going back to the data collection and transformation step.

The method is described thereafter for on iteration N at time t+1.

In reference to FIG. 5, by way of at least one embodiment, in a step E1, the monitoring module 10 collects metric data characterizing the computing device 20 over a predetermined interval of time, called time-series. Said predetermined interval of time depends on the type of metric data. For example, in at least one embodiment the predetermined interval of time may be a minute, an hour, a day or a week or a month.

In a step E2, by way of one or more embodiments, the monitoring module 20 determines at least one seasonality pattern of said metric data over said predetermined interval of time. The determination of a seasonality pattern allows the monitoring module 20 to select the optimum forecasting model as described hereafter.

If a seasonality pattern has been previously determined (i.e., in a previous iteration) and stored in a memory zone accessible to the monitoring module 10, the monitoring module 10 may retrieved said stored seasonality pattern from said memory zone. Also, in one or more embodiments, extra information may be retrieved, such as the time of the last seasonality pattern determination.

If a seasonality pattern has never been determined for the metric of interest or if a seasonality pattern has been determined a long time ago or many iterations k ago (k>N, where N is the maximum number of iterations before considering a determined seasonality pattern as being outdated), then a seasonality pattern identification routine is activated.

The seasonality pattern identification routine is applied to a time-series tracking the metric of interest (e.g., CPU utilization, memory usage, network traffic, database transactions, etc.) to establish the presence of simple or composite seasonality patterns.

An example of a simple seasonality pattern is illustrated on FIG. 2, by way of one or more embodiments, where time (dates) is on the X-axis (abscissa) and memory usage is on the Y-axis (ordinate). A simple seasonality pattern is a similar pattern (i.e., in shape, amplitude and duration) that is repeated periodically, for example daily in the example of FIG. 2, according to one or more embodiments of the invention.

FIG. 3 shows an example of a composite seasonality pattern, where time (dates) is on the X-axis (abscissa) and memory usage is on the Y-axis (ordinate), according to one or more embodiments of the invention. A composite seasonality pattern is a combination of simple patterns and at least one other pattern or absence of pattern over a defined period of time. In the example of FIG. 3, by way of at least one embodiment, the metric observed shows daily simple patterns during the weekdays and no activity during the weekend. A composite seasonality pattern could be described as one simple pattern that repeats every week. However, in at least one embodiment, defining a composite seasonality pattern (“weekdays-weekend” in the example of FIG. 3) allows to use recognition algorithms that can detect such pattern in a shorter time interval than the ones requested to find a simple seasonality pattern (at least twice the unit of time). This description of the simple and composite seasonality patterns can be extended to shorter or longer time units (hours, days, weeks, months, etc.).

If the time-series of metric data acquired in step E1 contains enough data to perform simple pattern recognition, then step E2 may be achieved successfully. For example, in at least one embodiment, if a daily pattern needs to be identified, at least two days of data are needed. If there is not enough data, seasonality pattern cannot be assigned. The simple pattern recognition may be performed by employing a discrete 1-D Fourier transform on the time-series of metric data, and by analyzing the resultant frequency-domain spectrum. For example, in at least one embodiment, if a daily pattern is present, a peak with a large magnitude at the frequency corresponding to one day will be present and detected in step E2. Otherwise, no seasonality pattern can be assigned to the time-series.

Composite seasonal patterns also exhibit large magnitude peaks as simple seasonality patterns. For example, in at least one embodiment, the weekdays-weekend composite seasonality pattern illustrated on FIG. 3 shows a large magnitude peak at around the frequency corresponding to one day, as its simple seasonality pattern counterpart (the daily seasonality pattern of FIG. 2). To distinguish between a simple or composite seasonality pattern, a composite seasonality pattern recognition algorithm may be used, if enough data is present. In the example of the weekdays-weekend composite pattern, at least seven days of data are needed. In the case in which the weekdays-weekend composite seasonality pattern is considered as a simple weekly pattern, a minimum of 14 days of data are needed. The composite pattern recognition thus allows one to reduce by half the minimum amount of data requested.

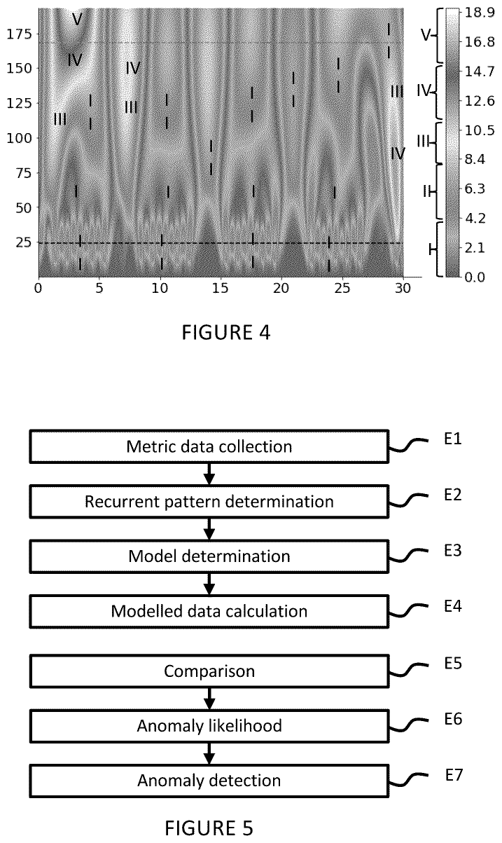

The composite seasonality pattern recognition algorithm may analyze the evolution of the simple seasonality patterns in time by using continuous wavelet transform. Wavelet functions such as Mexican hat or Gaussian may be used for the analysis. By fixing the frequency at a certain value (e.g., the frequency corresponding to one day), the monitoring module 10 may trace how the respective Fourier peaks evolves in time. For example, in at least one embodiment, to identify the composite weekdays-weekend pattern, the monitoring module 10 may analyze the frequency-time 2D wavelet transform map as shown on FIG. 4 (where time (days) is on the X-axis (abscissa) and FT peak frequency converted to hours is on the Y-axis (ordinate)) and focus on the cross-section with a frequency corresponding to one day. Statistical quantities such as mean, median, or standard deviation are further evaluated within a moving window on this cross-section. If the moving statistical quantities lie outside the interval defined by dynamically updated lower and upper thresholds, then the composite weekdays-weekend pattern is assigned to the time series of interest.

For example, in at least one embodiment, thresholds may be chosen according to the null hypothesis rejection procedure, e.g., by imposing a confidence level of 97% or higher. Null hypothesis rejection is a standard procedure used in statistics. Dynamic thresholds may be a Z-score chosen on a certain level, where the statistical measure of the distance of a certain observation forms the mean of a set of data. For example, in at least one embodiment, using properties of normal distribution Z-score equal to 3 means statistically that 99,7% of observations lie within the chosen thresholds.

Both simple and composite seasonality pattern recognition algorithm may improve their results by increasing the size of the historical metric data obtained in step E1.

In a step E3, by way of at least one embodiment, the monitoring module 10 defines the time-series modelling method and parameters once the seasonality pattern of the time-series of metric data has been established (no seasonality pattern, simple seasonality pattern or composite seasonality pattern).

One of models that may be used is the exponential smoothing Holt-Winters additive model with level (lₜ) and trend (bₜ) components. Seasonality components, if the time-series exhibit a seasonality pattern, may be added.

The modelled data ŷₜ₊₁, evaluated at time t+1, can be calculated as follows:

$${\hat{y}}_{t + 1 \vert f} = {l}_{t} + {b}_{t} + {s}_{t + 1 - m ( k + 1 )}$$

where the level component at time t, lₜ, is defined as:

$${l}_{t} = α ( {y}_{t} - {s}_{t - m} ) + ( 1 - α ) ( {l}_{t - 1} + {b}_{t - 1} )$$

and the trend component at time t, bₜ:

$${b}_{t} = β * ( {l}_{t} - {l}_{t - 1} ) + ( 1 - β \text{*)} {b}_{t - 1}$$

Seasonality component is added as follow:

$${s}_{t} = γ ( {y}_{t} - {l}_{t - 1} - {b}_{t - 1} ) + ( 1 - γ ) {s}_{t - m}$$

Where α is a level coefficient, β is a trend coefficient, γ is a season coefficient, and sₜ₋ₘ is the seasonal component.

Those coefficients may be calculated in a known manner by optimization techniques, such as, for example, grid search, least squares optimization, local search, etc.

Metric data collected in step E1 may be used, after step E2, to obtain a set of optimized parameters to be used in the modelling phase. The step E3 of data modelling is not restricted to exponential smoothing based techniques and may be performed by other forecast techniques such as ARIMA or Neural Networks.

In the modelling phase, at each iteration, observations (collected metric data) are collected at t+1 with value yₜ₊₁. The time step (t, t+1) may be constant for all measurements. If that is not the case, a resampling procedure may be needed to ensure equal time space between measurements.

Historical time-series of metric data may be used to optimize the parameters of the chosen model. Then, the model is applied to the same [t; t+1] interval to calculate the modelled data ŷₜ₊₁.

At the end of the data modelling, the model components for level (l), trend (b^{*}) and season(s) are re-optimized according to the observation received in the t−t′ time window.

At this point, the window can be moved, and observation are collected from time t+1 to time t+2 for further modelling. Also, the coefficients for level (α), trend (β) and season (γ), may be re-optimized to ensure that data modelling is constantly up to date if model performances decrease over time.

The model may be self-adjusted at each time step with new measurements, ensuring fast adaptation. The use of a moving window may reduce the computational effort. A moving window is defined as a time window of N time steps. Optimization of the model and calculation of the model data are done for each time step, but the model is saved only at the end of the moving window.

In the limit in which the moving window is reduced to a single step size, one may obtain real-time results (model data ŷₜ), according to one or more embodiments of the invention.

In a step E4, the monitoring module 10 calculates modelled data using the equation:

ŷ_{t+1|t}=lₜ+bₜ+sₜ₊₁₋ₘ₍ₖ₊₁₎ using the model coefficients determined in step E3 and the metric data collected in step E1.

In a step E5, the monitoring module 10 compares the calculated modelled data with the collected metric data to calculate a score characterizing the difference between the calculated modelled data and the collected metric data.

A score may be defined from the observed data, yₜ, and the modelled ones, ŷₜ. The score may be defined to be equivalent to the residuals, namely the difference between ŷₜ, and yₜ, but other functions may be defined, such as the positive residuals (if residual is negative, score is zero, otherwise is equal to the residual)), the square root of residuals, or others.

In a step E6, the monitoring module 10 calculates the anomaly likelihood for each data of the collected metric data using the N last calculated scores.

From the score, the monitoring module 10 calculates the likelihood L of yₜ to be an anomaly from the Q-function:

$$L = 1 - Q ( \frac{x - MN}{STD} )$$

where mean (MN) and standard deviation (STD) are calculated from the last N scores, and x is the mean of the last n score, where N>>n,

$$Q ( z ) = \frac{1}{2} erfc ( \frac{z}{\sqrt{2}} )$$

$$And$$

$$z = ( \frac{x - MN}{STD} ) .$$

The anomaly likelihood assessment, thanks to the use of rolling windows of size N and n for the scores, where N>>n, allows the system to dynamically adjust to new behaviors of IT operational metric values but at the same time making it robust to noise. Robustness and adjustability may be modified by changing N and n. If N decreases, the anomaly likelihood assessment adjusts better to quick changes of the measured data (for example, change of trend or pattern) but it will be less robust to data noise. If N increases too much, the model may become very robust but also less precise in recognizing anomalies. Similarly for n: for very small n, the model may become very sensitive and recognize noise as anomaly, while for very large n, the model may not be able to recognize anomalies. For these reasons, n may be set between 1 and a few tens of points, while N may be at least 2 orders of magnitude larger. The exact choice of n and N depends on the frequency of the collected data and the requested responsiveness of the model. For example, in at least one embodiment, if data are collected each second and the model must recognize changes of behavior occurring in a few seconds, the size of n has to be very small (not spanning data for more than a few seconds). However, in at least one embodiment, if the model must react to changes occurring in hours, n has to be increased to include data on a larger time scale (hour). Accordingly, N has to be adjusted to be at least 2 orders of magnitude larger than n.

In a step E7, by way of one or more embodiments, the monitoring module 20 detects an anomaly on a data when the probability that the value of said data is an anomaly is greater than a predetermined threshold. Historical scores may advantageously be used for calculating the likelihood of a value of the time-series to be an anomaly. If there are not enough score points, likelihood may be irrelevant.

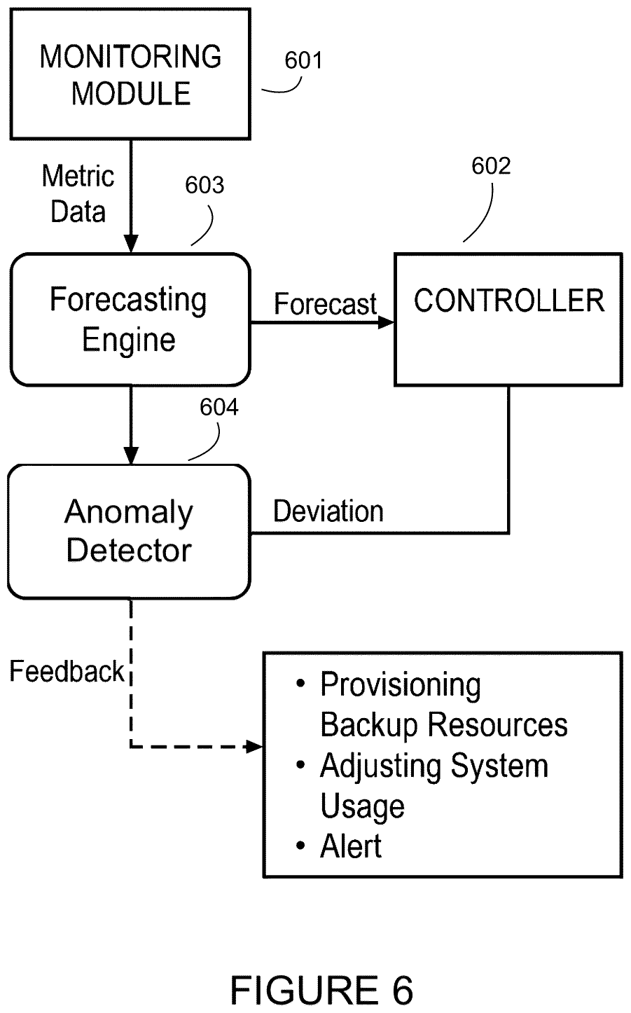

FIG. 6 illustrates an example of a computing system including a monitoring module and a controller module according to one or more embodiments of the invention.

In at least one embodiment of the invention, the system includes a hardware module 601, such as a controller, microcontroller, field-programmable gate array (FPGA), or dedicated processing unit, that is connected to the monitoring module 602 and that executes model inference and issues control signals based on the anomaly that is detected and the set of optimized parameters.

In one or more embodiments, the computing device includes one or more resources. In at least one embodiment, the method includes transmitting the anomaly that is detected to the controller and modifying one or more system operation parameters, via the controller, when the anomaly likelihood exceeds a dynamic threshold over a moving time window.

In one or more embodiments, the modifying the one or more system operation parameters, via the controller, includes one or more of enabling or disabling features of the computing device based on the seasonality pattern that is detected or based on a frequency of the anomaly, allocating or deallocating the one or more resource, issuing an alert when the anomaly likelihood exceeds the dynamic threshold over the moving time window, wherein the alert may include a severity level, a predicted metric value, an affected resource of the one or more resources, and a timestamp of the anomaly.

In at least one embodiment, the modifying the one or more system operation parameters, via the controller, may include generating a recommendation in response to the anomaly that is detected, the recommendation comprising a proposed action comprising one or more of scaling resources, rescheduling tasks, terminating a process, initiating a backup, retraining the interval-specific model, or throttling a service of the computing device.

In at least one embodiment, the reallocating the one or more resources is in anticipation of predicted performance degradation based on historical pattern analysis. In one or more embodiments, the method also includes predicting resource usage of the one or more resources of the computing device ahead of time based on historical telemetry data of the seasonality pattern of the metric data over time. In at least one embodiment, the predicting the resource usage is used to trigger automatic provisioning or deprovisioning of the one or more resources.

In one or more embodiments, the anomaly is defined as a deviation from a predicted normal system usage path determined by the interval-specific model.

In one or more embodiments, the method also includes transmitting outputs of the modelled data to an enterprise dashboard or external device in real time.

By way of one or more embodiments, the enabling or disabling features of the computing device may include one or more of enabling or disabling processor cores or adjusting processor frequency; activating or suspending swap memory or cache flush operations; toggling GPU acceleration or compute offload modes; enabling, disabling, or throttling network interfaces or communication protocols; modifying operating system-level policies including scheduling, logging, or process isolation; activating or suspending background services or job schedulers; enabling enhanced security protocols, restricting network access, or disabling application-level modules.

In at least one embodiment, the modifying the one or more system operation parameters, via the controller, includes modifying one or more of hardware subsystems of the computing device, operating system configuration parameters, active or scheduled processes of the computing device, and access control policies, application service states.

In one or more embodiments, the modifying the one or more system operation parameters, via the controller, includes modifying the system operation parameters based on whether the anomaly that is detected is classified as transient, persistent, or predictive in nature.

At least one embodiment of the invention includes a closed-loop feedback mechanism wherein an outcome of the modifying the one or more system operation parameters from the controller is fed back into the monitoring module to refine future forecasts.

In one or more embodiments, the allocating or deallocating the one or more resources, via the controller, includes using an orchestration platform API.

In at least one embodiment, the allocating the one or more resources includes instantiating one or more virtual machines, containers, or computing nodes.

In one or more embodiments, the deallocating the one or more resources includes terminating low-priority services or migrating workloads to lower-utilization hardware.

By way of one or more embodiments, the monitoring module forecasts metric data and calculates the anomaly likelihood. In at least one embodiment, the controller triggers proactive actions based on predicted anomalies and feeds the results back to update model parameters.

In at least one embodiment, the monitoring module forecasts metric data, such as CPU, GPU, or memory usage, for multiple future time steps using predictive models (e.g., Holt-Winters, ARIMA, LSTM). When the forecasted values diverge from expected seasonal norms or fall outside of learned tolerance bands, an anomaly score is generated for each future point.

In at least one embodiment, the controller receives the forecast and anomaly likelihoods, evaluates deviation trends, and issues a response action prior to system performance degradation to enhance the computing device and the system. Response actions, for example. include dynamic adjustment of compute resource allocation, preemptive deployment of additional resources, and generation of alerts.

In one or more embodiments, the actions may be triggered automatically by the controller in response to anomaly scores exceeding a dynamic threshold, or as a preventive measure when predicted resource utilization crosses a risk threshold within a future window.

In at least one embodiment, a closed-loop feedback mechanism records the outcomes of the controller actions and uses this data to update forecasting models, allowing adaptive learning based on actual system behavior.

According to one or more embodiments of the invention, the controller, coupled to the monitoring module, may modify system operations based on output from the anomaly likelihood and forecasting components. These modifications are performed in response to predicted or detected deviations in one or more metric data streams such as CPU, GPU, memory, disk I/O, or network utilization. The system may operate in an automated or semi-automated fashion and may execute mitigation procedures in real-time or near-real-time to avoid system performance degradation or downtime.

The following are non-limiting examples of system operations that may be modified in accordance with outputs from the predictive monitoring system:

AUTO-SCALING OF COMPUTATIONAL RESOURCES

Upon predicting that CPU utilization is likely to exceed a threshold (e.g., 85%) within a forecast window of N future time intervals, the system may initiate provisioning of additional compute instances or containers. This preemptive action avoids performance bottlenecks before they occur.

DYNAMIC LOAD REDISTRIBUTION

If memory usage on a given virtual machine exhibits anomalous behavior, the controller may initiate redistribution of applications or microservices to underutilized nodes within a server cluster. This may involve container migration or job rescheduling.

PREEMPTIVE BACKUP OR SNAPSHOT TRIGGERING

In response to anomalous growth in disk usage or I/O load, the system may trigger preemptive backups or create system snapshots to preserve state and data integrity ahead of a potential threshold breach.

TASK OR APPLICATION RESCHEDULING

If usage patterns suggest that a batch process or automated job is executing during unexpected hours (e.g., late at night or on weekends) with a high anomaly score, the system may reschedule the task to a predicted non-peak window to reduce system strain.

ADAPTIVE ALERT GENERATION

The system may issue tiered alerts based on the likelihood and projected severity of anomalies. For example, an alert generated when the system predicts a 95% likelihood of a RAM overload within the next 10 minutes may include recommendations such as restarting a service, allocating swap space, or preparing failover nodes.

APPLICATION ISOLATION OR THROTTLING

When a particular process consistently triggers anomalous patterns outside expected seasonality norms (e.g., an unauthorized application running during holidays), the system may automatically reduce its CPU priority or terminate it to maintain system stability.

FORECAST MODEL SWITCHING BASED ON PATTERN SHIFT

The monitoring module may detect shifts from simple to composite seasonal patterns (e.g., weekday-weekend usage differentials) and automatically switch forecasting techniques or retrain model parameters to maintain accuracy.

RESOURCE WARM-START OR PREFETCHING

When GPU workloads are forecasted to spike, the system may preload neural network models or datasets into memory to reduce startup latency, effectively preparing the system for upcoming demand before it occurs.

In one or more embodiments, these operational modifications may be coordinated through integration with orchestration platforms (e.g., Kubernetes, Apache Mesos, AWS Auto Scaling) and may include application-specific responses such as scaling out, throttling, rebooting, or redeploying services.

FEEDBACK LOOP LEARNING

In at least one embodiment, outcomes of executed operational modifications are recorded and used to update the forecasting model. This closed-loop feedback allows the system to improve its predictive accuracy and responsiveness over time by learning from intervention success or failure.

In one or more embodiments, the controller may model and predict use of the one or more resources of the computing device, and predict an optimal use of the resources to adjust usage of the IT resources accordingly.

In at least one embodiment, the resources include, but are not limited to, one or more of the following: CPU usage, GPU cycles, memory allocation (e.g., RAM, cache, virtual memory), disk storage utilization, read/write I/O rates, network bandwidth consumption, latency, number of active application threads, virtual machine or container resource metrics, instance provisioning status in a cloud environment, thermal or power metrics, and any system- or application-level performance or security indicators that are quantifiable over time.

In one or more embodiments, the forecasting and anomaly detection system may track, model, and influence the behavior of one or more of the resources either directly through system-level APIs or indirectly via integration with orchestration platforms, container managers, hypervisors, or cloud service providers.

In one or more embodiments, based on the anomaly that is detected and calculated and based on the modelled data that is calculated, the controller may issue system usage adjustment commands, such as dynamically throttling computational tasks, scheduling compute jobs to backup nodes, or activating power-saving states on underutilized resources of the computing device. These adjustments may occur automatically or in cooperation with higher-level orchestration systems.

In at least one embodiment, the controller may adjust system usage policies based on trends of the anomaly likelihood or seasonality patterns detected of the metric data. For example, if a consistent composite seasonality pattern is recognized (e.g., high memory usage during weekdays), the controller may automatically pre-allocate additional memory during predicted peak periods. Conversely, during off-peak times, the controller may disable or pause certain non-critical processes or services to conserve resources.

Furthermore, in one or more embodiments, when anomalies exceed a specified confidence or dynamic threshold, the controller may initiate usage-limiting responses, such as throttling resource access of the resources, altering logging granularity, or triggering auxiliary diagnostic routines. The controller may also log these adjustments for auditability and feedback into future anomaly modeling. Such self-regulatory behavior enables the system to adapt dynamically to evolving usage environments without manual reconfiguration.

In at least one embodiment, via the controller, the method includes modifying system operation parameters or selectively enabling or disabling features based on real-time or predicted anomaly patterns, enabling adaptive behavior in response to detected shifts in performance or workload profiles.

In at least one embodiment, the features are configurable or controllable subsystems or functions of the computing device that may be turned on, off, suspended, restarted, throttled, or adjusted in response to the model's forecasts or anomaly scores.

In at least one embodiment, features of the computing device include hardware, software, or firmware capabilities that can be selectively enabled, disabled, paused, resumed, throttled, or reconfigured in response to detected or predicted anomalies. Such features include processor or GPU control states, memory and I/O subsystems, network interface configurations, operating system scheduling and logging behavior, application-layer services, and device security configurations such as firewall settings or session restrictions.

In one or more embodiments, the system may enable or disable said one or more features of the computing device based on the detected anomaly, the frequency of the anomaly, or the predicted trajectory of system behavior. These features may include hardware-level, operating system-level, network-level, or application-level capabilities that affect the performance, stability, or security of the computing device.

By way of at least one embodiment, the features may include:

Processor-level features such as activating or deactivating specific CPU cores, disabling hyperthreading, or reducing clock speed.

GPU-related features such as enabling/disabling compute acceleration modes or reallocating GPU memory.

Memory and storage management features such as enabling swap file usage, flushing caches, disabling background memory-intensive services, or suspending I/O-heavy logging.

Network interface and communication controls such as enabling/disabling Wi-Fi or Bluetooth, shutting off virtual network interfaces, or limiting data transfer protocols during congestion.

Operating system features such as changing task scheduling priorities, activating safe mode, limiting concurrent threads, or sandboxing processes.

Security features including activating firewall rules, disabling exposed network ports, requiring multi-factor authentication, or locking sessions that exhibit anomalous access patterns.

Application-layer features such as disabling optional service modules, suspending analytics or telemetry collection, pausing machine learning inference, or disabling user-facing graphical features.

In at least one embodiment, predicted future usage trends are determined by applying one or more time-series forecasting models to historical metric data. The system may use Holt-Winters exponential smoothing, ARIMA, or neural networks to project future values for CPU, memory, storage, and other IT resource metrics. Forecasting incorporates seasonality components where applicable and may be adapted in real time based on newly collected data.

Additionally, in one or more embodiments, the system compares forecasted metric values to observed values using a score function, allowing it to predict when a system behavior is trending toward abnormal or resource-intensive states. These trends are evaluated over rolling statistical windows and used to calculate the likelihood of anomalous or overload conditions. When a high-confidence usage spike is forecasted, the system may automatically allocate or deallocate one or more computing resources prior to the occurrence of the predicted condition.

In at least one embodiment, the system monitors the schedule of tasks or jobs executing on the computing device, such as background jobs, data processing tasks, or scheduled service operations. Each task may have an associated resource profile based on historical behavior (e.g., CPU or memory footprint, duration, and priority). The monitoring module forecasts future system usage based on seasonal patterns and time-series modeling. If a task is scheduled to execute during a forecasted high-utilization window, the controller may reschedule that task to a different time period, preemptively delay its execution, or throttle its priority to prevent system overload. This scheduling adjustment is performed dynamically, and may incorporate thresholds for acceptable impact, service-level agreements (SLAs), or policy-based execution constraints.

In one or more embodiments, this mechanism reduces the likelihood of performance degradation caused by the overlap of scheduled task execution with anomalous or resource-intensive system behavior.

In one or more embodiments, when the anomaly likelihood exceeds a defined threshold, the system generates alerts and/or recommendations. Alerts are notifications delivered to administrators, monitoring consoles, or external systems and may include metadata such as anomaly type, metric involved, severity level, and prediction confidence.

By way of at least one embodiment, the recommendations are system-generated advisories that suggest responsive actions based on the predicted behavior. These may include adjusting resource limits, rescheduling jobs, restarting services, provisioning additional capacity, or isolating processes. Recommendations may be presented in dashboards or exported through APIs for manual or automated approval.

In at least one embodiment, resource allocation or deallocation is initiated when the anomaly likelihood exceeds a threshold or when forecasted resource utilization trends indicate a risk of saturation or underutilization.

In one or more embodiments, the controller communicates with an infrastructure orchestration layer using standard APIs to provision, resize, or remove computing resources. For example, the system may use Kubernetes Horizontal Pod Autoscaler to increase the number of application containers in response to predicted CPU saturation.

In at least one embodiment, the controller automatically allocates or deallocates one or more computing resources based on predicted future usage trends derived from forecast models. Allocation may be triggered when projected CPU, memory, or storage usage exceeds a predefined threshold within a future time window. Conversely, deallocation may be triggered when forecasted usage falls below an efficiency threshold, indicating underutilization.

In at least one embodiment, the controller may communicate with orchestration or resource management frameworks via API calls or control interfaces. For example, it may instruct a Kubernetes cluster to scale application pods, initiate the creation of new virtual machines via a cloud provider API, or terminate idle containers using local container management commands.

By way of one or more embodiments, the resources that may be allocated or deallocated include CPU shares or cores, memory allocation (RAM), persistent or ephemeral storage volumes, network bandwidth, or entire computing nodes. These operations may occur automatically without user intervention.

In at least one embodiment of the invention, the system further includes a predictive forecasting engine 603 that forecasts utilization metrics of distributed IT system components, such as CPU load, GPU activity, memory usage (RAM), and disk I/O. In at least one embodiment, the anomaly detection may occur via a separate and optional anomaly detector 604 coupled to the monitoring module and the controller.

The system leverages anomaly detection models described herein to analyze historical telemetry and usage data, and predict whether the system is likely to follow a normal or anomalous usage trajectory over several future time intervals.

When predicted resource usage patterns deviate significantly from established baselines, the controller generates alerts or flags anomalous trajectories, and takes preemptive action. Such preemptive actions may include adjusting job scheduling, provisioning redundant nodes, offloading tasks to auxiliary compute clusters, or triggering rollback or snapshot mechanisms to avoid downtime.

These real-time predictions are integrated with feedback loops so that anomaly classification models can continuously refine thresholds and baselines based on actual system responses and outcomes.

In at least one embodiment, the controller models and forecasts IT resource allocation under variable load conditions. In at least one embodiment, the controller uses predictive analytics and system performance modeling to determine future resource requirements and suggests optimized allocation strategies.

For example, the controller may determine that CPU usage in a high-throughput compute cluster is predicted to fall below a minimum utilization threshold during nighttime hours and suggest deallocating unused GPUs or reallocating them to batch processing workloads. Conversely, it may predict upcoming peak CPU loads and suggest pre-scaling virtual machines or containers in advance.

In one or more embodiments, the controller may output actionable resource management suggestions via an administrative interface or APIs consumed by automated orchestration platforms. These outputs are based not only on current usage metrics, but also on projected trends and learned seasonality patterns, thereby enabling proactive optimization of IT system behavior.

By way of one or more embodiments, the system is designed for integration with existing enterprise IT operations and observability stacks, including but not limited to performance dashboards, metrics aggregators (e.g., Prometheus, Datadog), and log analytics systems. The outputs of the predictive and anomaly detection models described herein may be rendered in real-time visualizations, or used to trigger automated playbooks, alert policies, or maintenance procedures, via the controller. By augmenting traditional IT operations tools with forward-looking system predictions, the system enhances operator situational awareness, improves decision-making under uncertainty, and reduces operational downtime.

For example, if the model predicts sustained CPU overload beyond a safe threshold, the controller may initiate resource reallocation commands to a redundant CPU cluster or reassign workloads through a load balancer. Likewise, when resource utilization is predicted to remain low, the controller may temporarily scale down resources or containerized services to reduce energy and cost overhead.

In at least one embodiment, the controller may interface with enterprise IT monitoring dashboards, where its outputs—such as projected CPU bottlenecks or flagged memory anomalies—are visualized alongside traditional metrics. In at least one embodiment, the controller ensures that the predictive system operates with low-latency, deterministic response times, making the system suitable for critical infrastructure deployments where early warnings and resource adaptation must occur within milliseconds to seconds.

In at least one embodiment, upon detecting a high anomaly likelihood associated with future CPU utilization forecasts, the system triggers a controller to automatically initiate provisioning of additional compute nodes or containers to absorb the projected load, thereby preventing performance degradation. For example, the system calculates future resource usage and anomaly scores, therefore automatically initiating provisioning of additional compute nodes or containers to absorb the projected load leverages that foresight to maintain system stability.

In at least one embodiment, when memory usage on a given virtual machine is projected to exceed a critical threshold, the monitoring module interfaces with a resource manager to redistribute load by reassigning application tasks to underutilized nodes. For example, by way of one or more embodiments, forecasting and trend detection can inform redistribution decisions across a server cluster

In at least one embodiment, if storage consumption exhibits an anomalous upward trend with a high anomaly likelihood, the controller may initiate a preemptive backup of critical data to external storage before threshold exhaustion occurs.

In at least one embodiment, the system identifies anomalous usage during off-hours and responds by modifying the execution time of batch jobs or scheduled tasks, shifting them to a non-peak window.

In at least embodiment, the system generates tiered alerts based on predicted resource overuse and recommends specific actions to IT staff, such as restarting services, provisioning memory, or initiating service failover.

In at least one embodiment, when a process consistently exhibits behavior flagged as anomalous and deviates from established seasonal norms, the system automatically lowers its CPU priority or initiates a shutdown procedure to preserve system availability.

In response to a shift from simple to composite seasonal behavior (e.g., weekday vs. weekend pattern), the monitoring module automatically switches its forecasting strategy from daily pattern analysis to composite model recognition, and adjusts anomaly thresholds accordingly.

For example, in at least one embodiment, if GPU utilization is forecasted to spike due to an expected inference workload, the system preloads the necessary models into memory to reduce latency and prevent cold-start issues,

1. An iterative method for monitoring a computing device, said computing device comprising one or more resources and being characterized by metric data to be monitored, said iterative method comprising:
collecting said metric data over a predetermined interval of time at each iteration,
wherein said metric data comprises total central processing unit consumption of the computing device, memory usage of the computer device, database transactions, network traffic, or a number of applications running on the computing device,
wherein said metric data is generated by a virtual machine installed on the computing device, wherein said virtual machine collects values from variables of interest to analyze,
detecting a seasonality pattern of said metric data over said predetermined interval of time,
obtaining a set of optimized parameters using said metric data to be used in a modelling phase to determine an interval-specific model,
determining said interval-specific model, using said set of optimized parameters, representing the seasonality pattern that is detected, defining a time-series modelling method and said set of optimized parameters once the seasonality pattern of the metric data is established,
wherein historical time-series of said metric data are used to optimize said set of optimized parameters,
calculating modelled data using said interval-specific model that is determined and the metric data that is collected,
comparing the modelled data that is calculated with the metric data that is collected to calculate a score characterizing a difference between the modelled data that is calculated and the metric data that is collected,
calculating an anomaly likelihood for each data of the metric data that is collected using the score that is calculated, said anomaly likelihood being a probability that a value of said each data is an anomaly,
detecting said anomaly on said metric data when said probability that the value of said each data is said anomaly is greater than a predetermined threshold,
updating said set of optimized parameters of said interval-specific model at said each iteration to dynamically adapt said anomaly to changes in values of said each data in said metric data, such that said iterative method self-adjusts on real-time to said seasonality pattern that is detected, wherein said seasonality pattern is a composite seasonality pattern, such that said composite seasonality pattern allows a reduction of a minimum amount of said historical time-series of said metric data that is required by half,
transmitting said anomaly that is detected to a controller,
modifying one or more system operation parameters, via said controller, when the anomaly likelihood exceeds a dynamic threshold over a moving time window,
wherein said modifying said one or more system operation parameters, via said controller, comprises one or more of
enabling or disabling features of said computing device based on the seasonality pattern that is detected or based on a frequency of said anomaly,
allocating or deallocating said one or more resources;
issuing an alert when the anomaly likelihood exceeds the dynamic threshold over the moving time window, wherein the alert comprises a severity level, a predicted metric value, an affected resource of said one or more resources, and a timestamp of the anomaly;
generating a recommendation in response to the anomaly that is detected, the recommendation comprising a proposed action comprising one or more of scaling resources, rescheduling tasks, terminating a process, initiating a backup, retraining said interval-specific model, or throttling a service of said computing device.

2. The iterative method according to claim 1, wherein the modelled data comprising ŷ_{t+h|t} is calculated at time according to a formula of:
$${\hat{y}}_{t + h \vert f} = {l}_{t} + {hb}_{t} + {s}_{t + h - m ( k + 1 )}$$
where:
a level lₜ at time t is defined as:
$${l}_{t} = α ( {y}_{t} - {s}_{t - m} ) + ( 1 - α ) ( {l}_{t - 1} + {b}_{t - 1} )$$
where α is a level coefficient,
a trend component bₜ at time t is defined as:
$${b}_{t} = β * ( {l}_{t} - {l}_{t - 1} ) + ( 1 - β \text{*)} {b}_{t - 1}$$
where β is a trend coefficient,
a seasonality component is added as follows:
$${s}_{t} = γ ( {y}_{t} - {l}_{t - 1} - {b}_{t - 1} ) + ( 1 - γ ) {s}_{t - m}$$
where γ is a season coefficient.

3. The iterative method according to claim 1, wherein the score deviates from a mean of N previous calculated scores when an anomaly-likelihood function L is below the predetermined threshold, where:
$$L = 1 - \frac{1}{2} erfc ( \frac{x - MN}{\sqrt{2} \times STD} )$$
and where x is the mean of the N previous calculated scores with N>>n, MN is the mean of the N previous calculated scores and STD is a standard deviation of the N previous calculated scores.

4. The iterative method according to claim 1, wherein the detecting the seasonality pattern of said metric data over said predetermined interval of time comprises retrieving a previously detected pattern or determining a new pattern.

5. The iterative method according to claim 1, wherein the seasonality pattern is a seasonality pattern which is a periodically repeated pattern.

6. The iterative method according to claim 5, wherein the seasonality pattern comprises one or more of
a combination of
at least one first peak of values of the metric data that is collected, and
at least one second peak of a different shape or amplitude or duration than said at least one first peak,
no peak.

7. A non-transitory computer program comprising instructions which, when the non-transitory computer program is executed by a computer, cause the computer to carry out an iterative method for monitoring a computing device that comprises one or more resources, said computing device being characterized by metric data to be monitored, said iterative method comprising:
collecting said metric data over a predetermined interval of time at each iteration,
wherein said metric data comprises total central processing unit consumption of the computing device, memory usage of the computer device, database transactions, network traffic, or a number of applications running on the computing device,
wherein said metric data is generated by a virtual machine installed on the computing device, wherein said virtual machine collects values from variables of interest to analyze,
detecting a seasonality pattern of said metric data over said predetermined interval of time,
obtaining a set of optimized parameters using said metric data to be used in a modelling phase to determine an interval-specific model,
determining said interval-specific model, using said set of optimized parameters, representing the seasonality pattern that is detected,
defining a time-series modelling method and said set of optimized parameters once the seasonality pattern of the metric data is established,
wherein historical time-series of said metric data are used to optimize said set of optimized parameters,
calculating modelled data using said interval-specific model that is determined and the metric data that is collected,
comparing the modelled data that is calculated with the metric data that is collected to calculate a score characterizing a difference between the modelled data that is calculated and the metric data that is collected,
calculating an anomaly likelihood for each data of the metric data that is collected using the score that is calculated, said anomaly likelihood being a probability that a value of said each data is an anomaly,
detecting said anomaly on said metric data when said probability that the value of said each data is said anomaly is greater than a predetermined threshold,
updating said set of optimized parameters of said interval-specific model at said each iteration to dynamically adapt said anomaly to changes in values of said each data in said metric data, such that said iterative method self-adjusts on real-time to said seasonality pattern that is detected, such that composite seasonality patterns are calculated with a reduced number of historical data,
transmitting said anomaly that is detected to a controller,
modifying one or more system operation parameters, via said controller, when the anomaly likelihood exceeds a dynamic threshold over a moving time window,
wherein said modifying said one or more system operation parameters, via said controller, comprises one or more of
enabling or disabling features of said computing device based on the seasonality pattern that is detected or based on a frequency of said anomaly,
allocating or deallocating said one or more resources;
issuing an alert when the anomaly likelihood exceeds the dynamic threshold over the moving time window, wherein the alert comprises a severity level, a predicted metric value, an affected resource of said one or more resources, and a timestamp of the anomaly;
generating a recommendation in response to the anomaly that is detected, the recommendation comprising a proposed action comprising one or more of scaling resources, rescheduling tasks, terminating a process, initiating a backup, retraining said interval-specific model, or throttling a service of said computing device.

8. A computing system comprising:
a monitoring module that monitors a computing device that comprises one or more resources, said computing device being characterized by metric data to be monitored,
wherein said monitoring module, via a communication link is configured to
collect metric data over a predetermined interval of time at each iteration,
wherein said metric data comprises total central processing unit consumption of the computing device, memory usage of the computer device, database transactions, network traffic, or a number of applications running on the computing device,
wherein said metric data is generated by a virtual machine installed on the computing device, wherein said virtual machine collects values from variables of interest to analyze,
detect a seasonality pattern of said metric data over said predetermined interval of time,
obtain a set of optimized parameters using said metric data to be used in a modelling phase to determine an interval-specific model,
determine said interval-specific model, using said set of optimized parameters, representing the seasonality pattern that is detected, define a time-series modelling method and said set of optimized parameters once the seasonality pattern of the metric data is established,
wherein historical time-series of said metric data are used to optimize said set of optimized parameters,
calculate modelled data using said interval-specific model that is determined and the metric data that is collected,
compare the modelled data that is calculated with the metric data that is collected to calculate a score characterizing a difference between the modelled data that is calculated and the metric data that is collected,
calculate an anomaly likelihood for each data of the metric data that is collected using the score that is calculated, said anomaly likelihood being a probability that a value of said each data is an anomaly,
detect said anomaly on said each data when said probability that the value of said each data is said anomaly is greater than a predetermined threshold,
update said set of optimized parameters of said interval-specific model at said each iteration to dynamically adapt said anomaly to changes in values of said each data in said metric data, such that said iterative method self-adjusts on real-time to said seasonality pattern that is detected, such that composite seasonality patterns are calculated with a reduced number of historical data,
transmit said anomaly that is detected to a controller;
a controller coupled to said monitoring module, wherein said controller is configured to
modify one or more system operation parameters, via said controller, when the anomaly likelihood exceeds a dynamic threshold over a moving time window,
wherein said modify said one or more system operation parameters, via said controller, comprises one or more of
enabling or disabling features of said computing device based on the seasonality pattern that is detected or based on a frequency of said anomaly,
allocating or deallocating said one or more resources;
issuing an alert when the anomaly likelihood exceeds the dynamic threshold over the moving time window, wherein the alert comprises a severity level, a predicted metric value, an affected resource of said one or more resources, and a timestamp of the anomaly;
generate a recommendation in response to the anomaly that is detected, the recommendation comprising a proposed action comprising one or more of scaling resources, rescheduling tasks, terminating a process, initiating a backup, retraining said interval-specific model, or throttling a service of said computing device.

9. The computing system according to claim 8, further comprising said computing device.

10. The computing system according to claim 9, wherein the computing device is a computer or a server or a cluster of one or more computers and servers.

11. The iterative method according to claim 1, wherein said reallocating said one or more resources is in anticipation of predicted performance degradation based on historical pattern analysis.

12. The iterative method according to claim 1, further comprising predicting resource usage of said one or more resources of the computing device ahead of time based on historical telemetry data of said seasonality pattern of said metric data over time.

13. The iterative method according to claim 12, wherein said predicting said resource usage is used to trigger automatic provisioning or deprovisioning of said one or more resources.

14. The iterative method according to claim 1, wherein said anomaly is defined as a deviation from a predicted normal system usage path determined by the interval-specific model.

15. The iterative method according to claim 1, further comprising transmitting outputs of the modelled data to an enterprise dashboard in real time.

16. The iterative method according to claim 1, wherein said enabling or disabling features of said computing device comprises one or more of
enabling or disabling processor cores or adjusting processor frequency;
activating or suspending swap memory or cache flush operations;
toggling GPU acceleration or compute offload modes;
enabling, disabling, or throttling network interfaces or communication protocols;
modifying operating system-level policies including scheduling, logging, or process isolation;
activating or suspending background services or job schedulers;
enabling enhanced security protocols, restricting network access, or disabling application-level modules.

17. The iterative method according to claim 1, wherein said modifying said one or more system operation parameters, via said controller, further comprises modifying one or more of hardware subsystems of the computing device, operating system configuration parameters, active or scheduled processes, access control policies, application service states.

18. The iterative method according to claim 1, wherein said modifying said one or more system operation parameters, via said controller, further comprises modifying said system operation parameters based on whether the anomaly that is detected is classified as transient, persistent, or predictive in nature.

19. The iterative method according to claim 1, further comprising a closed-loop feedback mechanism wherein an outcome of said modifying said one or more system operation parameters from the controller is fed back into the monitoring module to refine future forecasts.

20. The iterative method according to claim 1, wherein said allocating or deallocating said one or more resources, via said controller, comprises using an orchestration platform API.

21. The iterative method according to claim 1, wherein said allocating said one or more resources comprises instantiating one or more virtual machines, containers, or computing nodes.

22. The iterative method according to claim 1, wherein said deallocating said one or more resources comprises terminating low-priority services or migrating workloads to lower-utilization hardware.
